(19) United States
(12) Patent Application Publication
(10) Pub. No.: US 2003/0137177 A1
(43) Pub. Date: Jul. 24, 2003

(54) Portable headrest

(76) Inventor: Robin Scott Nyman, McDonough, GA (US)

Correspondence Address: WEATHERLY & ASSOCIATES, LLC, 3330 CUMBERLAND BOULEVARD, SUITE 500, ATLANTA, GA, 30339-5985, US

(21) Appl. No.: 10/351,139

(22) Filed: Jan. 24, 2003

Related U.S. Application Data
(60) Provisional application No. 60/352,067, filed on Jan. 24, 2002.
(60) Provisional application No. 60/352,084, filed on Jan. 24, 2002.

(51) Int. Cl. B60N 2/48

(52) U.S. Cl. 297/397

(57) ABSTRACT

A portable headrest which includes two padded tubular segments connected by a flexible web is described. Each tubular segment has a free end portion that includes fasteners to permit the user to connect these free end portions adjustably and detachably to each other. The headrest may be made from one piece of fabric sewn to create a tubular structure having five compartments. The innermost compartment is the web. The two compartments immediately adjacent the web are the padded tubular segments. The two outermost compartments are the free end portions. Once the free end portions are connected, the user places the headrest such that the tubular segments are positioned adjacent opposing lateral sides of the back of his head. The headrest thus supports the user's head against uncomfortable rotation and tilting so that the user can sit and/or sleep while sitting more comfortably without straining his neck.

### CROSS REFERENCE TO RELATED APPLICATIONS

This application claims priority to U.S. Provisional Patent Application Serial No. 60/352,067 entitled “Device that operates independently in keeping the head stationary during relaxation while upper body is in backward reclining position” filed Jan. 24, 2002, and to U.S. Provisional Patent Application Serial No. 60/352,084 entitled “Device that operates independently in keeping the head stationary during relaxation while upper body is in backward reclining position” filed Jan. 24, 2002.

### BACKGROUND OF THE INVENTION

The present invention generally relates to a portable device for supporting the head of a user. More specifically, the invention is a headrest with which a user can support his head against undue rotation and/or tilting while he is seated or lying down. The user may also adjust the effective size of the headrest to alter the way in which the headrest supports his head. The user may also configure the headrest for use as a conventional pillow.

### SUMMARY OF THE INVENTION

The portable headrest of the present invention includes two padded tubular segments connected at one of their respective ends by a flexible web. The free end portions of the tubular segments (not connected to the web) include fasteners that permit the user to adjustably and detachably connect these free end portions to each other. In the embodiment illustrated in FIGS. 1-5, the headrest is constructed from one piece of fabric that is sewn to create a tubular structure having five distinct compartments. The innermost (middle) compartment is the web that connects the padded tubular segments, which are the two compartments immediately adjacent the web. The two outermost compartments are the free end portions.

The foregoing general description and the following detailed description are exemplary and explanatory only and do not restrict the claims directed to the invention. The accompanying drawings, which are incorporated in and constitute a part of this specification, illustrate exemplary embodiments of the invention and together with the textual description, serve to explain the principles of the invention.

### BRIEF DESCRIPTION OF THE DRAWINGS

FIG. 1 is a schematic front perspective generally illustrating the way in which a user would position his or her head in relation to the portable headrest of the invention.

FIG. 2 is a schematic side perspective generally illustrating the way in which a user in a seated position would rest his or her head on the portable headrest shown in FIG. 1.

FIG. 3 is a front perspective of an exemplary embodiment of a portable headrest according to the invention that illustrates the overall construction of the headrest and the configuration of the headrest when the free end portions are connected.

FIG. 4 is a top perspective of the headrest illustrated in FIG. 3.

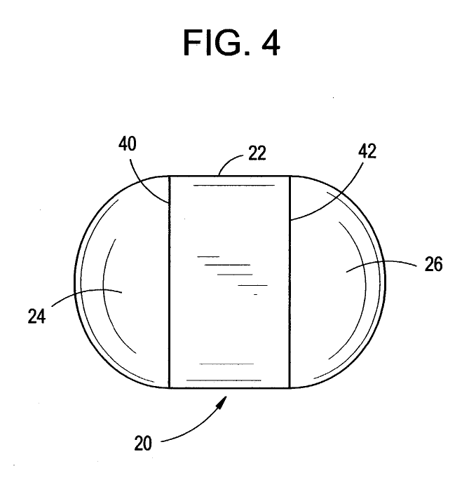

FIG. 5 is a bottom perspective of the headrest illustrated in FIG. 3.

### DETAILED DESCRIPTION OF THE INVENTION

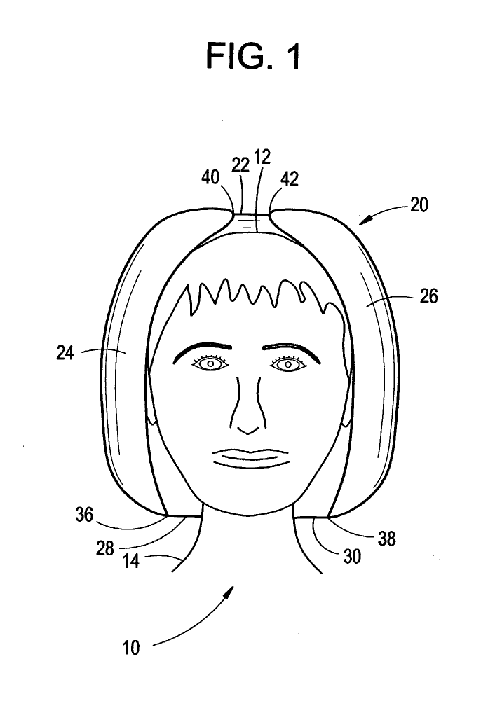

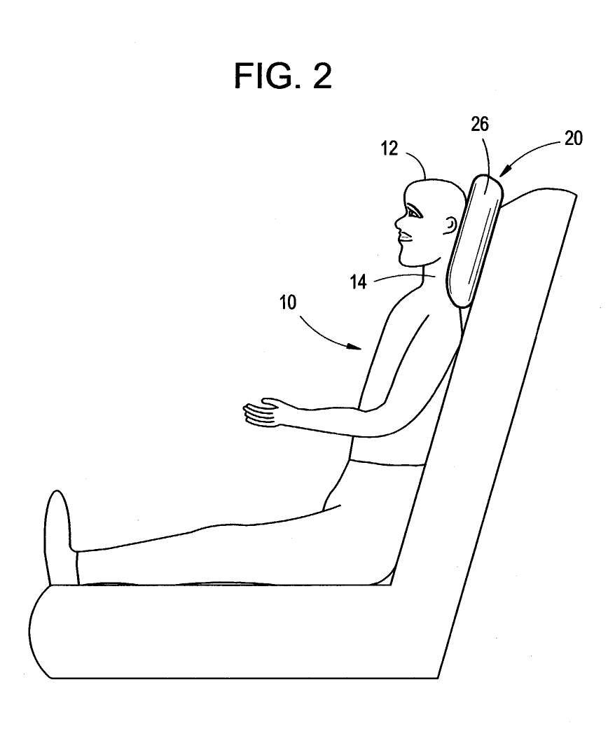

FIGS. 1 and 2 illustrate generally how the headrest 20 can be used to support a user's head 12 when the user 10 is in a seated position. Once the free end portions 28 and 30 of the headrest 20 are connected, the user 10 places the headrest 20 behind his head 12 such that the tubular segments 24 and 26 rest adjacent opposing lateral sides of his head 12. In this position, the headrest 20 supports the user's head 12 against undue rotation and tilting from side to side. The support provided by the headrest 20 enables the user 10 to sit more comfortably and sleep without the neck strain caused when one's head tilts too far to one side or rotates too far to one side.

Alternatively, the user 10 can employ the headrest 20 as a conventional pillow by connecting the free end portions 28 and 30 so that the tubular segments 24 and 26 contact each other along their inside medial surfaces 44 and 46 such that little or no space remains between them. When the headrest 20 is in this configuration, the user 10 may use the headrest 20 like a conventional pillow. For example, the user 10 could lay his head 12 on top of the folded headrest 20. If the user desires a smaller pillow, he could disconnect the free end portions 28 and 30, extend the headrest 20 so that tubular segments 24 and 26 are extended generally in a line, and lay his head 12 or neck 14 on only one of the padded tubular segments 24 and 26.

The free end portions 28 and 30 of the illustrated embodiment of the headrest 20 adjustably and detachably connect to each other, preferably via complementary VELCRO® brand hook-and-loop fasteners, to form the headrest 20 into a closed shape that encircles the head 12 of the user 10 as illustrated in FIG. 1. For example, the hook portion 32 of the VELCRO® fastener is shown attached to the surface 28a of the free end portion 28, and the loop portion 34 of the VELCRO® fastener is shown attached to the surface 30a of the free end portion 30. Alternatively, the free end portions 28 and 30 could be detachably and adjustably connected using snaps, buttons, adjustable straps of the sort commonly found on adjustable-size baseball caps, or complementary hooks and clasps. The user 10 can vary the effective size of the headrest 20 by varying the degree to which the fasteners 32 and 34 (and thus the free end portions 28 and 30) overlap when mated. If the user 10 desires a tighter fit around his head 12, he can mate the fasteners 32 and 34 so that they overlap more. If the user desires a looser fit around his head, he can mate fasteners 32 and 34 so that they overlap less. The range of size adjustment is determined by the length of the free end portions 28 and 30 and the attachment options available with the fasteners used. In the illustrated embodiment, the linear range of size adjustment approximates the sum of the length of VELCRO® fasteners 32 and 34. Additionally, the effective size of the headrest 20 is infinitely adjustable within the range of size adjustment defined by the sum of the lengths of VELCRO® fasteners 32 and 34.

In the illustrated embodiment of the headrest 20, the free end portions 28 and 30 are unpadded. Such unpadded free end portions 28 and 30 do not support the user's neck 14 when the headrest 20 is used as shown in FIGS. 1 and 2. Alternatively, the free end portions 28 and 30 can be filled with padding material to support the user's neck 14. When the free end portions 28 and 30 are padded, they are preferably filled less densely with padding material than the tubular segments 24 and 26 so that the VELCRO® fasteners still mate in an approximately planar contact patch and the padding under the user's neck 14 is not uncomfortably thick. For example, the free end portions 28 and 30 may contain sufficient padding such that when fasteners 32 and 34 are mated the combination of the overlapping free end portions 28 and 30 is about as thick as either one of the tubular segments 24 and 26. When the free end portions 28 and 30 of this alternative embodiment are mated, the combination of free ends 28 and 30 support the user's neck 14 when the headrest 20 is used as illustrated in FIGS. 1 and 2. The density of padding stuffed into free end portions 28 and 30 can be increased or decreased to create a support for the user's neck 14 that is thicker or thinner than either of tubular segments 24 and 26 depending upon the amount of neck support desired.

The headrest 20 can be made easily and economically from a single rectangular piece of material that is cut to a length ranging from about 30 inches to 45 inches (which allows a range of sizes) and a width ranging from 3 inches to 13 inches or preferably 8 inches to 13 inches for a headrest designed for an adult. This width of material will result in a thickness of the padded tubular segments of from about 2 inches to 8 inches or preferably 5 inches to 8 inches for a headrest designed for an adult. First, the material piece is laid flat. As one looks at the material, length runs left to right and the width runs top to bottom. The material is folded so that the top edge aligns with the bottom edge. The aligned free top and bottom edges are joined together, preferably by sewing, along the entire length of the material to form a tube with open left and right ends, which ultimately become free end portions 28 and 30. After sewing, the material piece is turned inside out to hide the stitching. The web 22 is defined by two spaced apart lines of stitching sewn across the width of the tube in a direction approximately perpendicular to the longitudinal axis of the tube of material. Preferably the two lines of stitching (40 and 42 in the finished headrest 20) are spaced apart by about 1 to 8 inches to define a web 22 that is 1 to 8 inches long (measured in the longitudinal direction). The longer the web, the more padding the tubular segments 24 and 26 can accept while also permitting the padded tubular segments 24 and 26 to be folded easily into contact along their medial surfaces 44 and 46. Web 22 should preferably be at least about as long as the thickness of one of the padded tubular segments 24 and 26 if the thickness of the tubular segments 24 and 26 is the same. If the thickness of the tubular segment 24 is different from the thickness of the tubular segment 26, then the web 22 should preferably be at least about as long as half the sum of the thickness of tubular segment 24 and the thickness of the tubular segment 26. The thickness of a fully stuffed padded tubular segment 24 or 26 will be approximately twice the width of the sewn material (measured from top to bottom when the tube of material is laid out with the length running right to left and not filled with padding material) divided by π (pi). A shorter web 22 would increase the force required to fold tubular segments 24 and 26 so that medial surfaces 44 and 46 contact each other. A longer web 22 would allow tubular segments 24 and 26 to: (1) fold easily so that medial surfaces 44 and 46 come into contact and remain in contact with each other without significant folding force being applied and (2) slide to some degree against each other in a longitudinal direction.

The padded tubular segments 24 and 26 are formed by stuffing padding material, for example, polyester fiberfill or a mixture of fiberfill and batting, into each of the two open ends of the tube of material. The padding material is stuffed into the ends of the tube of material until the padding material fills each open section of the tube from stitches 40 and 42 to locations approximately 6 to 15 inches from those stitches. After each end of the tube is stuffed with padding material, each open end of the tube is closed with another line of stitching (line of stitching 36 for tubular segment 24 and line of stitching 38 for tubular segment 26). Lines of stitching 36 and 40 thus define tubular segment 24, and lines of stitching 38 and 42 thus define tubular segment 26. The free end portions 28 and 30 of the tube of material are then sewn shut with lines of stitching (not illustrated) across the width of the tube. Each of free end portions 28 and 30 in this example are from about 5 to 7 inches long.

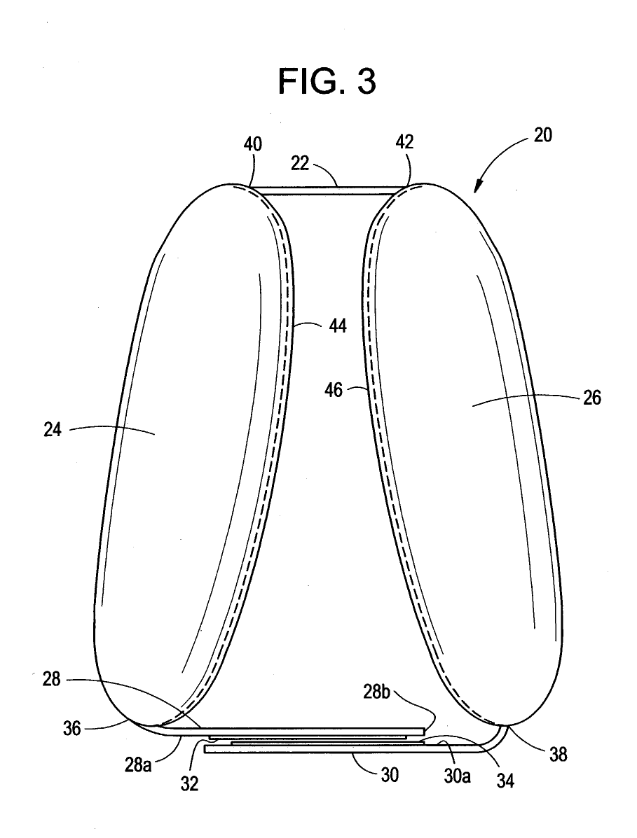

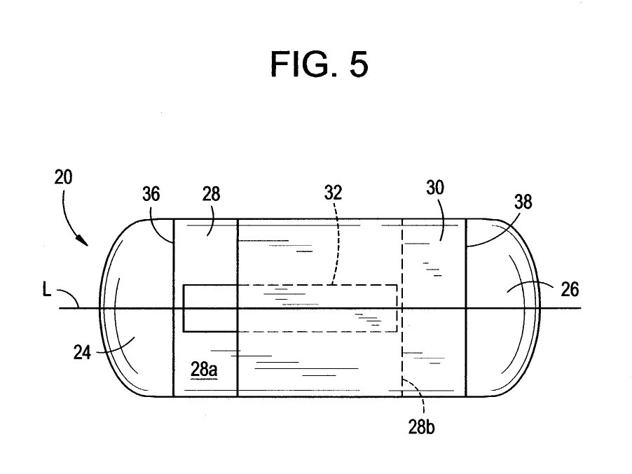

To complete the headrest 20, the complementary VELCRO® fasteners 32 and 34 are sewn onto the free end portions 28 and 30 respectively (see, e.g., FIG. 3). For example, a VELCRO® hook strip 32 of about 5 to 7 inches long can be sewn so that extends longitudinally along approximately the centerline L (shown in FIG. 5) from a location near stitching 36 to a location near the edge 28b (FIGS. 3 and 5) of the free end portion 28. The complementary VELCRO® loop strip 34 (which is not illustrated in FIG. 5 to enable a clearer description of VELCRO® hook strip 32) is similarly sewn onto surface 30a of free end portion 30 along centerline L (FIG. 3 and 5) such that it extends from a location near stitching 38 to a location near the other edge of free end portion 30.

The tubular segments 24 and 26 of the portable headrest 20 can be made of almost any material suitable for making conventional pillows including at least natural or synthetic woven fabrics (e.g., cotton, fleece, wool, polyester, nylon, and blends of such fibers) and natural or synthetic sheet materials (e.g., natural or synthetic rubber, or polyvinyl chloride sheet). A preferred material for the tubular segments 24 and 26 is a finely textured broad cloth or fleece because it is highly flexible, durable, washable, breathable, soft to the touch, and able to contain padding over a long period of time. The padding in the tubular segments 24 and 26 can also be made of almost any material suitable for use as padding in a conventional pillow including, among other materials: down, down/feather mixtures, natural fiber filling (e.g., cotton or wool) synthetic fiber filling (e.g., HOLLOFIL® or QUALLOFIL®), foam filling (e.g., open-cell or closed-cell polyfoam), natural or synthetic beads (e.g., polystyrene beads, dried beans, or buckwheat hulls), air, water, and gel. One preferred material used for the padding is 100% polyester fiberfill.

The web 22 that connects one tubular segment 24 to the other tubular segment 26 can be made of the same material used in the tubular segments 24 and 26 themselves, or the web 22 can be made of a different material. The same is true of the free end portions 28 and 30. Because the web 22 and the free end portions 28 and 30 need not contain padding in at least one embodiment, the may be made using straps, netting, or some other connective material poorly suited for containing padding. Additionally, the web 22 and the free end portions 28 and 30 may be made of the same material or materials different from each other.

Other embodiments of the headrest 20 and methods of making the headrest 20 according to the invention will be apparent to skilled artisans based on their consideration of the specification and practice of the headrest disclosed in this document. The applicant intends that the specification and examples described be considered as exemplary only, with the true scope and spirit of the invention being indicated by the following claims.

What is claimed is:

1. A headrest, comprising:
A. a first tubular segment containing a padding material and defining a first web end and a first free end portion;
B. a second tubular segment containing the padding material and defining a second web end and a second free end portion;
C. a flexible web connected to the first web end and the second web end; and
D. a first fastener connected to the first free end portion that is adapted to mate detachably and adjustably with a second fastener connected to the second free end portion.

2. The headrest of claim 1, in which the length of the web measured between the first web end and the second web end is greater than or equal to about half the sum of the thickness of the first tubular segment and the thickness of the second tubular segment.

3. The headrest of claim 2, in which the length of a portion of the first tubular segment that contains the padding material that is measured along a longitudinal axis of the first tubular segment is approximately 6 to 15 inches.

4. The headrest of claim 3, in which the first tubular segment is from about 2 to 8 inches thick.

5. The headrest of claim 4, in which the second tubular segment is from about 2 to 8 inches thick.

6. The headrest of claim 5, in which the first free end portion and the second free end portion contain none of the padding material.

7. The headrest of claim 6, in which the first tubular segment, the second tubular segment, the web, the first free end portion, and the second free end portion are all made of a first material.

8. The headrest of claim 5, in which the first free end portion contains the padding material.

9. The headrest of claim 8, in which the second free end portion contains the padding material.

10. The headrest of claim 1, in which the first fastener is a VELCRO® strip of hook material and the second fastener is a VELCRO® strip of loop material.

11. The headrest of claim 1, in which the length of a portion of the first tubular segment that contains the padding material that is measured along a longitudinal axis of the first tubular segment is approximately 6 to 15 inches.

12. The headrest of claim 1, in which the first tubular segment is from about 2 to 8 inches thick.

13. The headrest of claim 12, in which the second tubular segment is from about 2 to 8 inches thick.

14. The headrest of claim 1, in which the first free end portion contains the padding material.

15. The headrest of claim 14, in which the second free end portion contains the padding material.

16. The headrest of claim 1, in which the first free end portion and the second free end portion contain none of the padding material.

17. The headrest of claim 1, in which the first tubular segment, the second tubular segment, the web, the first free end portion, and the second free end portion are all made of a first material.

18. The headrest of claim 1, in which the first tubular segment and the second tubular segment are both made of a first material and the web is made of a second material different from the first material.

19. The headrest of claim 18, in which the first free end portion and the second free end portion are made of a third material that is different from the first material and different from the second material.

20. The headrest of claim 18, in which the first free end portion and the second free end portion are made of the second material.
